(19) United States
(12) Patent Application Publication
(10) Pub. No.: US 2006/0117312 A1
(43) Pub. Date: Jun. 1, 2006

(54) Device to serve software to a host device through a peripheral device and method thereof

(76) Inventor: Jung-soo Seo, Suwon-si (KR)

Correspondence Address: STANZIONE & KIM, LLP, 919 18TH STREET, N.W., SUITE 440, WASHINGTON, DC, 20006, US

(21) Appl. No.: 11/283,885

(22) Filed: Nov. 22, 2005

(30) Foreign Application Priority Data
Nov. 29, 2004 (KR) 2004-98472

(51) Int. Cl. G06F 9/44

(52) U.S. Cl. 717/168

(57) ABSTRACT

A device and method of serving software to a host device through a peripheral device, and/or a peripheral device to serve software to a host device. The software-serving method may include obtaining and storing host device software information, and/or host device installation software information, comparing information on the stored host device software to the stored host device installation software information, and determining whether to update the host device installation software. The software-serving method may also include sending the stored host device software to the host device if it is determined that the host device installation software needs to be updated. Thus, the method may serve updated host device software to any of a plurality of host devices, so the host device installation software may be more conveniently updated.

### CROSS-REFERENCE TO RELATED APPLICATIONS

This application claims benefit under 35 U.S.C. §119 from Korean Patent Application No. 2004-98472, filed on Nov. 29, 2004, the entire contents of which are incorporated herein by reference.

### BACKGROUND OF THE INVENTION

1. Field of the Invention

The present general inventive concept relates to a device to serve software, and more particularly, to a peripheral device, and a device to serve software to a host device through the peripheral device, and a method thereof.

2. Description of the Related Art

A personal computer (PC), which is used as a host device, includes installed software (S/W). There are various ways to install and update software on a PC, one convenient and general way is to download and install software into the PC through the Internet.

FIG. 1 is a block diagram illustrating a conventional method for updating software installed on a PC through the Internet 30. Referring to FIG. 1, PCs 20A, 20B, and 20C, which may represent a type of host device, can download and install updated software from a S/W server 40 using the Internet 30.

The PCs 20A, 20B, and 20C may share a common printer 10. If the PCs 20A, 20B, and 20C, for example, share the common printer 10, the printer driver S/W installed on the PCs 20A, 20B, and 20C may be the same.

The printer driver S/W on each of the PCs 20A, 20B, and 20C may require periodic updating. Therefore, an administrator of the PCs 20A, 20B, and 20C may be inconvenienced about performing updates, since the same task would have to be repeated three times.

The PCs 20A, 20B, and 20C may be managed by different administrators, thus, the printer driver S/W may be updated in some of the PCs 20A, 20B, and 20C, while other PCs may have not yet received updated software. Therefore, the PCs 20A, 20B, and 20C may share the same printer 10, but, unreasonably, each of the PCs 20A, 20B, and 20C may have a different printer driver S/W version installed to drive the printer 10.

### SUMMARY OF THE INVENTION

The present general inventive concept provides a peripheral device to serve software to one ore more host devices through the peripheral device and a method thereof. The software serving device may provide a convenient way to update the software in the one or more host devices.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a method of serving software. The method, comprising obtaining and storing host device software information used for a host device, obtaining and storing host device installation software installed on the host device, comparing information on the stored host device software to the stored host device installation software information, determining whether to update the host device installation software, and sending the stored host device software to the host device if it is determined that the host device installation software needs to be updated.

The method may be performed by a peripheral device connected to the host device.

The host device software may be obtained from an external device connected to the peripheral device.

The external device may be any of another host device connected to the peripheral device, another peripheral device connected to the host device, a first server connected to the peripheral device, and a second server connected to the peripheral device through a communication network.

The comparing of the information may comprise determining whether the host device installation software needs to be updated if a version of the stored host device software is more recent than a version of the host device installation software.

The method of serving software may further include sending to the host device a message inquiring whether to update the host device installation software if it is decided that the host device installation software needs to be updated, and sending the stored host device software to the host device if an update approval message is received from the host device as a response to an inquiry message.

The method may include if an update completion message is received from the host device as a response to the sending of the host device software, updating content of the stored host device installation software information.

The method may further include, if it is decided that the stored host device software is not installed in the host device, sending the stored host device software to the host device.

The host device software may be used for the host device to drive the peripheral device.

The foregoing and/or other aspects of the general inventive concept may also be achieved by providing a peripheral device, which may include a communication interface to connect at least one external device and at least one host device, a storage unit to store software and host device information, and a control unit to obtain and store host device software used for the host device in the storage unit through the communication interface, to obtain and store in the storage unit, through the communication interface, host device installation software information installed on the host device, and, if it is decided that the host device installation software needs to be updated, as a result of comparing the host device software information to the host device installation software information, to send to the host device, through the communication interface, the host device software stored in the storage unit of the peripheral device.

The host device software may be obtained from the external device connected to the communication interface, and the external device may be any of another host device connected to the communication interface, another peripheral device connected to the communication interface, a first server connected to the communication interface, and a second server connected to the communication interface through a communication network.

The control unit may determine that the host device installation software needs to be updated if a version of the stored host device software is more recent than a version of the host device installation software.

If an update completion message is received from the host device through the communication interface, as a response to the sending of the host device software, the control unit may update the content of the information of the host device installation software stored in the storage unit of the peripheral device.

The host device software may be used by the host device to drive the peripheral device.

The foregoing and/or other aspects of the general inventive concept may also be achieved by providing a system to serve software, which may include at least one host device and at least one peripheral device. The peripheral device may include, a communication interface connecting the peripheral device and the host device, a storage unit for storing host device software and host device installation software information, and a control unit for determining whether to serve updated software to the host device based on a comparison between the host device software and the host device installation software information.

The foregoing and/or other aspects of the general inventive concept may also be achieved by providing a method to serve software, which may include obtaining information on a host device software stored in a peripheral device, determining whether to replace the host device software based on a comparison of the host device software version to a version of a host device software of an external device, and if the version of the host device software of the external device is more recent than the host device software version stored in the peripheral device, then downloading the host device software of the external device, and replacing the host device software stored in the peripheral device.

The foregoing and/or other aspects of the general inventive concept may also be achieved by providing a device to serve software, which may include a peripheral device and an external device. The peripheral device may obtain information on a host device software stored in a peripheral device, and determine whether to replace the host device software based on a comparison of the host device software version to a version of a host device software of an external device, and if the version of the host device software of the external device is more recent than the host device software version stored in the peripheral device, then the host device software of the external device may be downloaded and replaced in the peripheral device.

The foregoing and/or other aspects of the general inventive concept may also be achieved by providing a device to form an image on a recording medium, which may include an image forming unit to form an image on a recording medium according to data received from an external device, a communication interface to communicate with the external device and a network, and a control unit to receive host device software information and host device installation software information of the external device, and to generate an update signal so that the host device software can be updated with host device installation software.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a conventional method for updating software installed on PCs using the Internet;

FIG. 2 is a block diagram illustrating a system to update software according to an embodiment of the general inventive concept;

FIG. 3 is a block diagram illustrating a peripheral device of the system of FIG. 2;

FIG. 4 is a flow chart illustrating a method of serving software to a host device through a peripheral device, according to an embodiment of the general inventive concept; and

FIG. 5 is a flow chart illustrating a software-obtaining and software-storing operation of a host device in the method illustrated in FIG. 4, according to an embodiment of the general inventive concept.

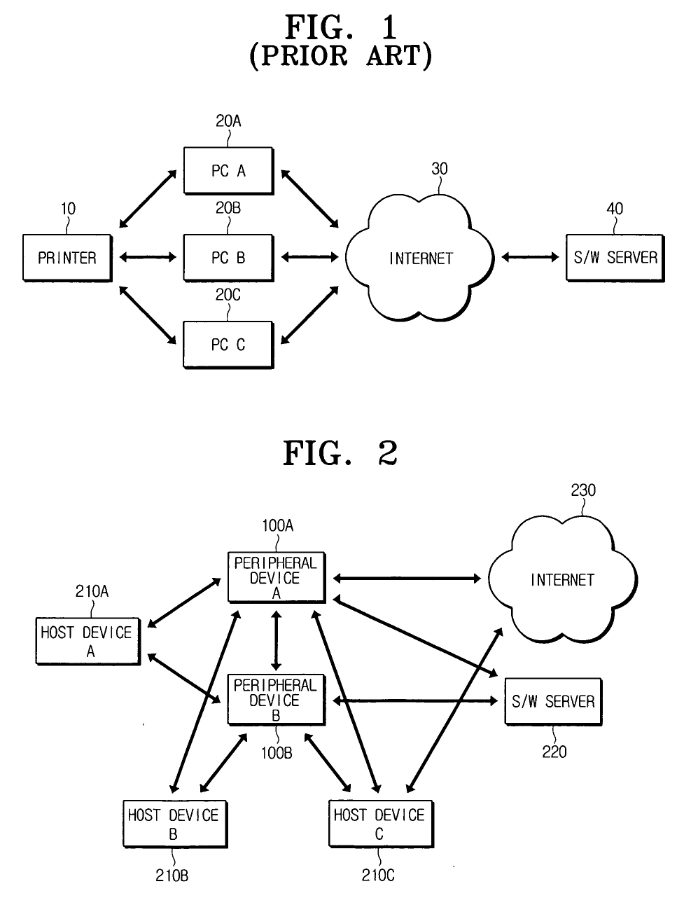

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 2 is a block diagram illustrating a system to update software according to an embodiment of the general inventive concept. In FIG. 2, the system includes, for example, peripheral devices 100A and 100B, host devices 210A, 210B and 210C, a software (S/W) server 220, and the Internet 230.

The peripheral devices 100A and 100B may be connected to at least one of the host devices 210A, 210B and 210C, and may perform tasks at the request of the one or more of the connected host devices 210A, 210B and 210C. The host devices 210A, 210B and 210C may be, for example, personal computers (PCs), and the peripheral devices 100A and 100B, may be, for example, image-forming devices for printing data received from one or more of the PCs.

The peripheral devices 100A and 100B may download software from the S/W server 220, since the peripheral devices 100A and 100B are connected to the S/W server 220. Furthermore, the peripheral devices 100A and 100B may also be connected to the Internet 230, and capable of downloading the software from a different device, for example a different S/W server (not shown) connected to the Internet 230. In addition, FIG. 2 illustrates that peripheral devices 100A and 100B may also be interconnected to communicate with each other. As a result, the peripheral devices 100A and 100B may send and receive the software to each other.

Although the system of FIG. 2 shows the peripheral devices 100A and 100B connected to the host devices 210A, 210B and 210C are connected to a network such as the Internet 230 or a device such as the S/W server 220, the system is not limited thereto. With regard to a remote software updating and/or installing procedure, the present general inventive concept may be applied to various types of systems and configurations. Therefore, other example systems and configurations, not shown in the drawings, may also apply the general inventive concept described throughout the specification.

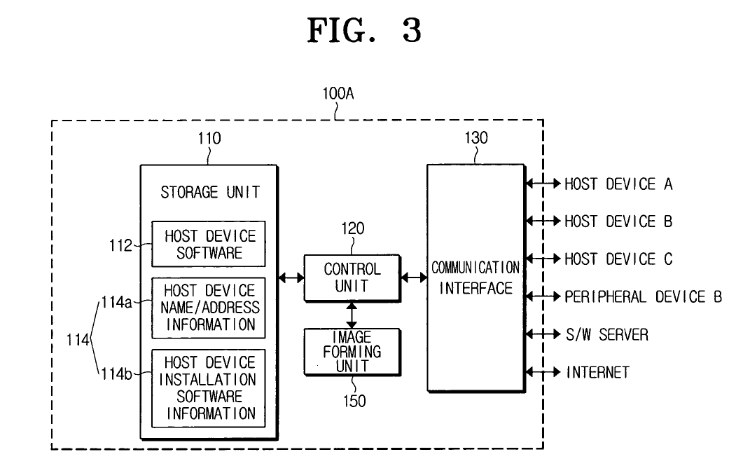

Hereinafter, certain details of the peripheral devices 100A and 100B, illustrated in FIG. 2, will be described. The peripheral devices 100A and 100B illustrated in FIG. 2 may be the same or a similar type of device, thus for simplicity, a description will be made with regard to only peripheral device 100A, as illustrated in FIG. 3.

FIG. 3 is a block diagram illustrating the details of the peripheral device 100A, as illustrated in FIG. 2. The peripheral device 100A may serve the software to a connected host device and, the software may be used by the host device (Hereinafter, referred to as ‘host device software’). Further, the host device software may be used by a host device to drive peripheral devices. In FIG. 3, the peripheral device 100A includes, for example, a storage unit 110, a control unit 120, and a communication interface 130.

The communication interface 130 may receive first host device software from one or more connected external devices, and/or may receive host device information from one or more connected host devices. The host device information may include, for example, i) information regarding a name and an address of the connected host device, and/or ii) information regarding second host device software installed on the connected host device (hereinafter, referred to as ‘host device installation software’). Further, the information on the host device installation software may contain one or more types of information, for example: name, version, creation date, and/or other related information.

The storage unit 110 may include a recording medium on which data and programs may be recorded. For example, the storage unit 110 may store the programs used to drive the peripheral device and the data generated during operation of the peripheral device. In addition, the storage unit 110 may store host device software 112 and/or host device information 114. The information stored in the storage unit 110 may be received by the communication interface 130. The host device information 114 may contain host device name and/or address information 114a and/or host device installation software information 114b.

The control unit 120 may provide some or all of the overall operations of the peripheral devices 100A and 100B. In particular, the control unit 120 may control the operations of obtaining and storing the host device software 112 of external devices, and/or the operation of serving the host device software 112 to a host device based on the contents of the host device information 114.

The peripheral device 100A may further include a component 150 connected to the control unit 120 to form an image on a sheet of paper. The control unit 120 may receive data corresponding to the image from the host device 100A, and the component 150 may print the image using the received data.

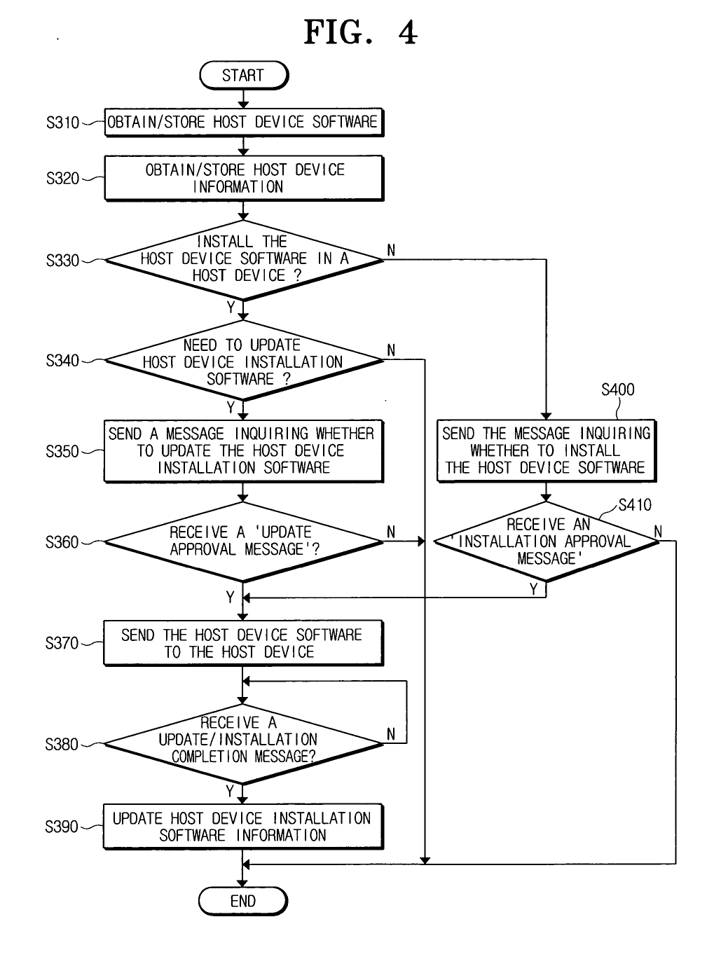

Hereinafter, a process of obtaining and storing host device software 112, and serving the host device software 112, will be described with reference to FIG. 4. FIG. 4 is a flow chart illustrating a method of obtaining and serving software to a host device through a peripheral device, according to an embodiment of the general inventive concept.

Referring to FIGS. 2-4, the peripheral device 100A may obtain and store the host device software 112 (operation S310). The operation S310 may be performed during a process where the control unit 120 stores the host device software 112, which may be obtained from external devices through the communication interface 130 in the storage unit 110. Description will be made later in detail regarding the operation S310 for obtaining and storing the host device software.

The peripheral device 100A may obtain and store host device information 114, related to, for example, the host device 210A (operation S320).

Operation S320 may be performed during a process that includes the control unit 120 storing the host device information 114 in the storage unit 110. The host device information may be obtained from the host device 210A via the communication interface 130.

The host device information 114 may contain the host device name, address information and/or the host device installation software information. Accordingly, the host device information 114 obtained in operation S320 may contain, for example, the name and/or address information of the host device 210A and/or the installation software information that may be installed on the host device 210A.

The peripheral device, for example, 100A may determine whether the host device software 112, stored in operation S310, is installed on the host device 210A. The determination of whether to install the host device software on the host device 210A may be based on the contents of the host device information 114 stored in the storage unit 110 (operation S330). The operation S330 may be performed by the control unit 120 comparing, for example, the name of the host device software 112 stored in operation S310 to the name of the host device installation software extracted from the host device installation software information 114b, stored in operation S320.

Once it is determined that the host device software 112 is installed on the host device 210A, then the peripheral device 100A may decide whether the host device installation software installed on the host device 210A requires an update (operation S340). The execution of operation S340 may include comparing the information of the host device software 112, stored in the operation S310, to the host device installation software information 114b, stored in the operation S320. An example comparison may include determining if the available version of the host device software 112 is more recent than a version the host device installation software previously installed. If the available version is more recent than the previous version then the host device may require an update (operation S340). The comparison may be performed by the control unit 120, and may include extracting host device installation software information 114b to determine the previously installed version of the host device software 112.

If it is determined that the host device installation software information 114 requires an update in operation S340, then the peripheral device 100A may send an update inquiry message to the host device 210A (operation S350). The update inquiry message may be a message inquiring whether to update host device software 112 and/or the host device installation software 114 on the host device 210A. In operation S350, the control unit 120 may send an update inquiry message to the host device 210A. The address of the host device 210A may be obtained through the host device name/address information 114a stored in the operation S320.

The update inquiry message sent to the host device 210A may appear on a display of the host device 210A, a user may then decide whether to update the host device 210A. Further, when the user accepts an update approval, the host device 210A may send an update approval message to the peripheral device 100A as a response to the update inquiry message (operation S360). It is possible that the host device may be automatically updated with the host device software upon the determination of whether the host device installation software needs to be updated.

If the peripheral device, for example, 100A, receives the update approval message from the host device 210A (operation S360), the peripheral device 100A may send the host device software 112 stored in operation S310 to the host device 210A (operation S370). The host device 210A may install the received host device software. Once the host device software is installed, the host device 210A may send an update completion message to the peripheral device 100A, in response to receiving the host device software 112.

If the peripheral device 100A receives the update completion message from the host device 210A (operation S380), the peripheral device 100A may update the host device installation software information 114b stored in operation S320 (operation S390), since changes may have been made to the version information of the host device installation software of the host device installation software information 114b.

On the other hand, if it is decided in operation S340 that the update of the host device installation software is unnecessary, for example, the host device installation software version is the same as or more recent than the currently available version of the host device software 112 then the subsequent steps are not performed. Further, if the host device installation software version previously installed on the host device is more recent than the currently available version of the host device software 112 then the peripheral device 100A may receive the host device installation software currently installed on the host device 210A and replace the older version of the software with the later version.

If the peripheral device 100A does not receive the update approval message from the host device 210A in operation S360, that is, if an update disapproval message is received, then the subsequent operations are not performed, since the decision of the user of the host device 210A will be respected.

If it is determined that the host device software 112 is not installed on the host device 210A in operation S330, then the peripheral device 100A may send an installation inquiry message to the host device 210A (operation S400). Further, if the peripheral device 100A receives an installation approval message from the host device 210A in response to the installation inquiry message sent in operation S400, then operations S370 to S390 will be performed (operation 410). In operation S380, the message received by the peripheral device 100A from the host device 210A may be the installation completion message.

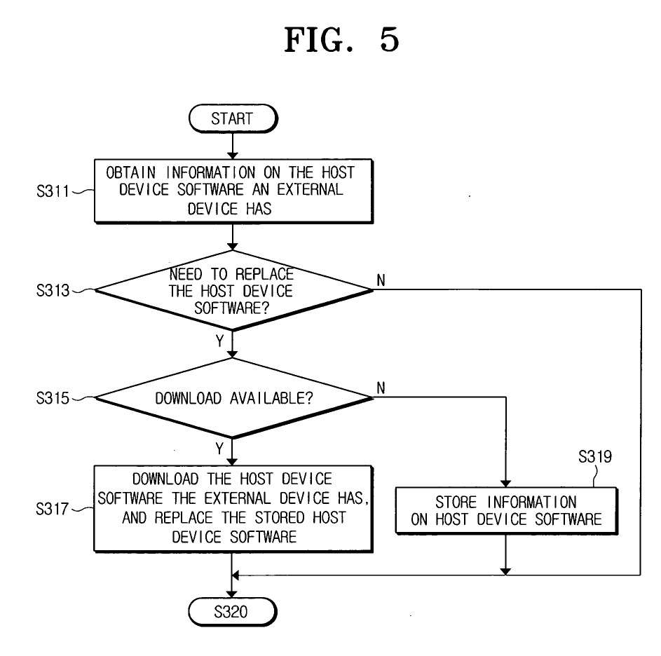

Hereinafter, operation S310 as illustrated in FIG. 4 will be described in greater detail with reference to FIG. 5. Referring to FIG. 5, a flow chart illustrates the various operations included in operation S310 of FIG. 4.

The peripheral device 100A may obtain information about the host device software 112 from an external device, which may be connected to the peripheral device 100A (operation S311). The external device may be any device connected to the peripheral device 100A. As illustrated in FIG. 2 and FIG. 3, the external devices may include, for example, another peripheral device 100B, host devices 210B and 210C, a software server 220, and/or the Internet 230.

The peripheral device 100A may determine whether to replace the host device software 112 stored in the storage unit 110 based on the information obtained in operation S311 (operation S313). Operation S313 may be executed when control unit 120 compares the version of the stored host device software 112 to the version of the host device installation software of the external device.

If it is determined that host device software 112 needs to be replaced in operation S313. For example, if the version of the host device software on the external device is more recent than the version of the stored host device software 112, then the peripheral device 100A may determine whether to download the more recent version of the host device software located on the external device (operation S315). If the host device software is downloaded in operation S315, the peripheral device 100A will replace the host device software 112 located on the peripheral device 100A with the more recent version that was downloaded from the external device (operation S317).

On the other hand, if it is determined that the download is not available in operation S315, the peripheral device 100A may store the information obtained in operation S311 in storage unit 110 (operation S319). The storing of the information obtained in operation S311 in the peripheral device 100A, allows the peripheral device 100A to use the information during subsequent attempts to download the host device software.

As described above the general inventive concept has included serving software to a host device through a peripheral device, and/or a peripheral device serving software to a host device. In an embodiment according to the general inventive concept, a peripheral device, for example, peripheral device 100A, may serve host device software 112 to a host device 210A. However, this example is only one example embodiment of the general inventive concept, and was provided for simplicity of explanation. In other examples, plural peripheral devices may be implemented in a similar manner to serve software to one or more host devices, the detailed embodiment of which will be omitted since such embodiment can be easily implemented by those skilled in the art through the above embodiment.

As aforementioned, the device and method of serving software can simultaneously serve host device software through a peripheral device to all host devices connected to the peripheral device. Accordingly, the present invention may reduce the level of inconvenience caused by separately updating installation software to each of a plurality of devices, thereby providing a method for updating installation software. Further, a same latest version of software may be installed on all devices connected to a peripheral device, thus permitting software installed on a plurality of devices to be the same version.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of serving software, comprising:
obtaining and storing host device software to be used in a host device;
obtaining and storing host device installation software information installed in the host device;
comparing information on the stored host device software to the stored host device installation software information, and determining whether to update the host device installation software; and
sending the stored host device software to the host device if it is determined that the host device installation software needs to be updated.

2. The method as claimed in claim 1, wherein the operations of obtaining and storing the host device software and the host device installation software information, comparing information on the stored host device software to the stored host device installation software information, and sending the stored host device software are performed by a peripheral device connected to the host device.

3. The method as claimed in claim 2, wherein, the obtaining and storing of the host device software comprises obtaining and storing the host device software from an external device connected to the peripheral device.

4. The method as claimed in claim 3, wherein the external device is one of another host device connected to the peripheral device, another peripheral device connected to the host device, a first server connected to the peripheral device, and a second server connected to the peripheral device through a communication network.

5. The method as claimed in claim 2, wherein, the comparing of the information comprises determining that the host device installation software needs to be updated and determining that a version of the host device software is more recent than a version of the host device installation software.

6. The method as claimed in claim 2, wherein the sending of the stored host device software to the host device comprises
sending to the host device a message inquiring whether to update the host device installation software if it is decided that the host device installation software needs to be updated; and
sending the stored host device software to the host device if an update approval message is received from the host device as a response to the inquiry message.

7. The method as claimed in claim 2, further comprising:
if an update completion message is received from the host device as a response to the sending of the host device software, updating content of the stored information on the host device installation software.

8. The method as claimed in claim 2, further comprising:
if it is decided that the stored host device software is not installed in the host device, sending the stored host device software to the host device.

9. The method as claimed in claim 2, wherein the host device software comprises software to be used in the host device to drive the peripheral device.

10. A peripheral device, comprising:
a communication interface connecting at least one external device and at least one host device;
a storage unit to store software and host device information; and
a control unit to obtain and store in the storage unit, through the communication interface, host device software used for the host device, to obtain and store in the storage unit, through the communication interface, host device installation software information installed on the host device, and, if it is decided that the host device installation software on the host device needs to be updated, as a result of comparing the host device software information to the host device installation software information, to send to the host device, through the communication interface, the host device software stored in the storage unit of the peripheral device.

11. The peripheral device as claimed in claim 10, wherein the host device software information is obtained from the external device connected to the communication interface, and the external device is any of another host device connected to the communication interface, another peripheral device connected to the communication interface, a first server connected to the communication interface, and a second server connected to the communication interface through a communication network.

12. The peripheral device as claimed in claim 10, wherein the control unit determines that the host device installation software needs to be updated if a version of the stored host device software is more recent than a version of the host device installation software.

13. The peripheral device as claimed in claim 10, wherein, if an update completion message is received from the host device through the communication interface, as a response to the sending of the host device software, the control unit updates the content of the information of the host device installation software stored in the storage unit of the peripheral device.

14. The peripheral device as claimed in claim 10, wherein the host device software is used by the host device to drive the peripheral device.

15. A system to serve software, comprising:
at least one host device; and
at least one peripheral device comprising:
a communication interface connecting the peripheral device and the host device,
a storage unit for storing host device software and host device installation software information, and
a control unit for determining whether to serve updated software to the host device based on a comparison between the host device software and the host device installation software information.

16. The system of claim 15, wherein the determining of whether to serve updated software further includes comparing a name of the host device software to a name of the host device installation software.

17. The system of claim 15, wherein the determining of whether to serve updated software further includes comparing a version of the host device software to a version of the host device installation software.

18. A method of serving software comprising:
obtaining information on a host device software stored in a peripheral device;
determining whether to replace the host device software based on a comparison of the host device software version to a version of a host device software of an external device, and if the version of the host device software of the external device is more recent than the host device software version stored in the peripheral device;
downloading the host device software of the external device; and
replacing the host device software stored in the peripheral device.

19. The method of claim 18, wherein if the download is not available,
storing the information obtained on the host device software in a storage unit.

20. The method of claim 19, wherein the information obtained is stored such that the peripheral device may use the information in subsequent attempts to download more recent host device software.

21. A device to serve software comprising:
a peripheral device; and
an external device, wherein the peripheral device obtains information on a host device software stored in a peripheral device, and determines whether to replace the host device software based on a comparison of the host device software version to a version of a host device software of an external device, and if the version of the host device software of the external device is more recent than the host device software version stored in the peripheral device, then the host device software of the external device is downloaded and replaced in the peripheral device.

22. The device of claim 21, wherein if the download is not available, the information obtained on the host device software is stored in a storage unit.

23. The method of claim 22, wherein the information obtained is stored such that the peripheral device may use the information in subsequent attempts to download more recent host device software.

24. A peripheral device to form an image on a recording medium, comprising:
an image forming unit to form an image on a recording medium according to data received from an external device;
a communication interface to communicate with the external device and a network; and
a control unit to receive host device software information and host device installation software information of the external device, and to generate an update signal so that the host device software can be updated with host device installation software.

25. The peripheral device of claim 24, wherein the network is the Internet.

26. The peripheral device of claim 24, wherein the control unit controls the image forming unit to print the image according to the data received from the external device.
